(19) United States
(12) Patent Application Publication
(10) Pub. No.: US 2014/0277994 A1
(43) Pub. Date: Sep. 18, 2014

(54) SLIDING MODE CONTROLLER FOR ENGINE THERMAL MANAGEMENT

(71) Applicant: International Engine Intellectual Property Company, LLC, (US)

(72) Inventors: Venkat Sunil Tanneru, Naperville, IL (US); Micahel Uchanski, Chicago, IL (US)

(21) Appl. No.: 13/799,884

(22) Filed: Mar. 13, 2013

(51) Int. Cl. F02D 45/00

(52) U.S. Cl. CPC F02D 45/00
USPC 701/102

(57) ABSTRACT

A sliding mode controller for one or more valves in an engine induction or exhaust system provides improved thermal control over an engine. Double discrete variable rate filters generate position and velocity profiles for various intake and exhaust valves. Alternatively, double discrete fixed rate filters may be used to generate position and velocity profiles. A control law includes a Signum function and is modified with a “boundary layer” to control valve chattering. Alternatively, gain scheduling may be used to remove valve chattering. A low pass filter on the controller output can be used to remove chattering phenomena.

### BACKGROUND

1. Technical Field

The technical field relates to thermal management on internal combustion engines

2. Description of the Technical Field

Exhaust gas recirculation (EGR) sub-systems on internal combustion engines, particularly diesel engines, are employed, among other reasons, to control cylinder temperature. Limiting cylinder temperature reduces the generation of NOx. Control over the quantity of exhaust gas recirculated from the exhaust manifold to the intake manifold of an engine is implemented using an EGR valve. The temperature of the exhaust gas in the exhaust manifold can be managed using thermal management (TM) valve usually located ahead of exhaust treatment sub-systems such as catalytic converters and diesel particulate traps. A TM valve is used to increase backpressure in an exhaust system which raises exhaust gas temperature.

Achieving close thermal control over engine operation may be comprised by valve positioning response times. When EGR valves and TM valves exhibit slow or unpredictable responses the ability to achieve emission targets can be compromised.

Sliding mode control (SMC) is a nonlinear method of control that affects the dynamics of a system by use of a discontinuous control signal. This results in the system “sliding” along a cross-section of the system's usual response area. By way of example, sliding mode control may represent simple hard switching between two states, such as off to on. Asymptotic convergence on a state is avoided and system sensitivity of variations in variable values during a transition are avoided. A system thus may be made more robust. Implementing sliding mode control involves selection of a manifold (a “sliding surface”) such that the system performance trajectory exhibits closer to target behavior and finding a feedback gain that keeps the performance trajectory on the sliding surface.

In SMC the response of a closed loop system is defined by the parameters in the controller and is independent of both changes in the controlled system and disturbances acting on it. The technique has found prior application to proportional solenoid valves. Such valves have a natural third order, non-linear response which varies from valve to valve. Fluid flow through such valves can produce forces which oppose movement of the valve resulting in difficulties in obtaining target responses using conventional control methods.

### SUMMARY

A sliding mode controller for one or more valves in an engine induction or exhaust system provides improved thermal control over an engine. Double discrete variable rate filters generate position and velocity profiles for various intake and exhaust valves. Alternatively, double discrete fixed rate filters may be used to generate position and velocity profiles. A control law includes a Signum function and is modified with a “boundary layer” to control valve chattering. Alternatively, gain scheduling may be used to remove valve chattering. A low pass filter on the controller output can be used to remove chattering phenomena.

The sliding mode controller algorithm has calibratable position and velocity profile generator. This helps achieve variable rise times per requirements. Double butterworth filters are used for generating fixed rate profiles. Double first order filters are used to generate variable rate profiles. The gains on the filters can changed to achieve desired position and velocity profiles. The Signum function part of the control law is modified to incorporate a boundary layer which reduces the chattering phenomena. Gain scheduling algorithm is used to reduce chattering. When the error is greater than a threshold, one set of gains with a higher magnitude is used. When less than a threshold, lower magnitude gains are used. A low pass filter is implemented on the controller output to remove chattering, and humming sound from the motor at the end stops.

### BRIEF DESCRIPTION OF THE DRAWINGS

FIG. 1 is a schematic diagram of an exemplary engine system.

FIG. 2 is a flow chart for a sliding mode controller.

FIG. 3 is a block diagram for a fixed rate filter design.

FIG. 4 is a series of response curves.

FIG. 5 is a graphical depiction of a plant model for a solenoid actuated valve.

FIG. 6 is a schematic for a sliding mode controller according to a prior art design.

FIG. 7 is a schematic for a sliding mode controller employing integral control.

FIG. 8 is a schematic for a sliding mode controller employing integral control and gain scheduling.

FIG. 9 is a schematic for a sliding mode controller employing a velocity observer.

FIG. 10 is a schematic for a filtered sliding mode controller.

FIG. 11 is a series of graphs illustrating effects of changes in the proportional term on position error for a valve.

FIG. 12 is a detailed graph of the control signal of FIG. 11.

FIG. 13 is a series of graphs illustrating effects of changes in gain.

FIG. 14 is a series of graphs illustrating effects of changes in gamma.

FIG. 15 is a series of graphs illustrating effects of changes in steady state error.

FIG. 16 is a series of graphs illustrating effects of changes in lambda on valve response.

FIG. 17 is a detailed graph of the control signal of FIG. 16.

FIG. 18 is a set of graphs illustrating the effect of changes in Eta on valve response.

FIG. 19 is a set of graphs illustrating the effect of changes in gamma on valve response.

FIG. 20 is a set of comparison graphs.

FIG. 21 is another set of comparison graphs.

FIG. 22 is a timing diagram illustrating valve chatter without gain scheduling.

FIG. 23 is a graphical illustration of control of chattering with gain scheduling.

FIG. 24 is a graph.

### DETAILED DESCRIPTION

In the following detailed description, like reference numerals and characters may be used to designate identical, corresponding, or similar components in differing drawing figures. Furthermore, example sizes/models/values/ranges may be given with respect to specific embodiments but are not to be considered generally limiting.

Referring now to the drawings, FIG. 1 depicts an internal combustion (IC) engine 10, associated induction/intake and exhaust systems, and an engine control module (ECM) 25. The exemplary IC engine 10 is a multiple cylinder 11 arrangement and is configured for compression-ignition operation, although the methods disclosed here are not limited to compression-ignition engines. Variable volume combustion chambers 13 are formed in the cylinders 11 between an engine head (not shown) and reciprocating pistons (not shown) that are attached to a crankshaft 23. The associated induction and exhaust systems include a intake throttle valve 82, an (inter)cooler 42, an exhaust gas recirculation (EGR) valve 32 and recirculated exhaust gas cooler 52, an intake manifold 50, an exhaust manifold and down-pipe 60, a thermal control valve 80 located in the exhaust and an exhaust after treatment sub-system comprising in downstream order a filter (PRE-DOC filter) 75, a diesel oxidation catalytic converter (DOC) 70 and a diesel particulate filter (DPF) 68.

The induction and exhaust systems also include an intake air compressing (turbo-charger) sub-system 40. The intake air compressing sub-system 40 comprises a fixed geometry exhaust turbines (FGT) 41 and an air compressor 39 which is driven by the FGT 41. The intake air compressing sub-system 40 extracts energy from the exhaust stream in order to compress air (boost) for delivery to the combustion chambers 13. The intake air compressing sub-system 40 can be constructed from superchargers in which case there will be no exhaust turbines and the sub-system becomes exclusively part of the induction system. A waste gate 28 on the FGT 41 allows control over the amount of energy extracted from the exhaust stream in order to vary the boost to the combustion chambers 13.

The compressor 39 draws intake air at near ambient pressure and temperature and compresses the air for delivery to the intake manifold 50 through an (inter)cooler 42. Delivering air at greater than ambient pressure to combustion chambers 13 increases the air mass in the combustion chambers over a naturally aspirated engine and thereby allows more fuel to be injected. Increased amounts of energy are released with each combustion cycle resulting in the increased output of mechanical power. Thermodynamic law predicts that the extraction of energy from the exhaust stream will reduce the temperature of the exhaust stream moving downstream from the exhaust manifold 60 to discharge from the FGT 41. A portion of the exhaust gas stream is forced from the exhaust manifold 60 through the EGR valve 32 (when open) to the intake manifold 50 since the pressure in the exhaust manifold is higher than the pressure in the intake manifold.

Various sensors may be installed on the IC engine 10 or associated with the various sub-systems to monitor physical variables and generate signals which may be correlated to engine 10 operation and ambient conditions. The sensors include an ambient air pressure sensor 12, an ambient or intake air temperature sensor 14, and an intake air mass flow sensor 16, all which can be configured individually or as a single integrated device. In addition there are an intake manifold air temperature sensor 18, and an intake manifold pressure sensor 20. Additional sensors may include an FGT waste gate duty cycle sensor (not shown) and an EGR valve position sensor 30. A tachometer 22 monitors rotational speed in revolutions per minute (N) of the crankshaft 23. Engine speed (N) may be derived from a cam shaft position sensor (not shown) in the absence of a crankshaft associated tachometer 22. An exhaust manifold temperature sensor 31 and an exhaust manifold pressure sensor 17 may be located in physical communication with the exhaust manifold 60. A post fixed geometry turbine pressure sensor 26 measures pressure of the exhaust gas upon discharge from the low pressure FGT 41 and the thermal management valve 80. A pressure difference sensor 27 measures pressure drop across the DPF 68. A temperature sensor 19 provides exhaust gas temperature after discharge from the PRE-DOC filter 75. The present disclosure outlines methods for the estimation of gas temperature in the exhaust manifold based on particular sets of sensors to supplement or replace exhaust manifold temperature sensor 31. The enumeration of the various sensors does not mean all are present on every vehicle or that others might not be present. Data links of various types (not shown) may be used to connect sensor readings to the ECM 25. The intake and exhaust sub-system configurations are exemplary and the present teachings can be applied to other arrangements of sub-system elements.

ECM 25 receives engine oil and engine coolant temperature measurements from IC engine 10 sensors (not shown). Torque demand 21 is a function of driver pedal position. Engine speed (N) and torque demand 21 are used to determine torque (R). Friction losses depend upon engine speed (N).

The readings from the sensors, where present, represent several operating variables, including: Tᵢₘ—intake manifold temperature from sensor 18; Pᵢₘ—intake manifold pressure from sensor 20; Tₐₘ—ambient temperature from intake air temperature sensor 14; Pₐₘ—ambient pressure from ambient air pressure sensor 12; WGT_{P}—high pressure FGT 41a waste gate 29 position from waste gate duty cycle sensor 28; EGVₚ—EGR valve 32 position from sensor 30; N—engine speed from tachometer 22; Pₑₘ—exhaust manifold pressure from exhaust manifold pressure sensor 17; Pₐₜ—exhaust pressure upon discharge from LP FGT 41b from post LP FGT pressure sensor 26; P_{pc}—pressure change across the DPF 68 from DPF pressure difference sensor 27, this value may be used to determine pressure at the outlet from the LP FGT 41b assuming pressure drop across the PRE-DOC 75 and DOC 70 are negligible; and, T_{pc}—exhaust gas temperature after discharge from the PRE-DOC 75 comes from a temperature sensor 19. An exhaust manifold temperature sensor 31 generating a measured value Tₑₘ for exhaust gas temperature in the exhaust manifold 60.

Referring to FIG. 2 a high level flow chart relating to design of a sliding mode controller for the EGR valve 32, the intake throttle valve 82, and the thermal management valve 80 is shown. A profile generator 202 generates target position and velocities for the given step change on position for the valves. Profile generation is done using double first order discrete filters. The idea is to maintain the target velocity profile for a given position profile based on appropriate gains 206. A sliding mode controller surface (S) calculation 208 is done to represent a surface combining the error on position and velocity using position feedback. The control law 210 is derived to drive\converge the surface (S) towards zero to minimize the error on position and velocity. For a given system, the controller is derived to drive the surface (S) towards 0. The velocity observer 212 is used to predict the velocity of the system in the absence of a velocity sensor. The velocity observer 212 is a first order linear function based on control input and position feedback. First order filter 214 on the control signal (U) which cuts of high switching frequencies and helps smooth out U to the discrete driver on the actuator.

Profile generator 202 is now considered in greater detail referring to FIG. 3. The target position and velocity profiles 308, 310 are generated using discrete low pass filters. Fixed rate and variable rate filters are used for this purpose. A double fixed rate butterworth filter 302, 304 is used for this purpose. The delta step change step on position is put through these back to back filters for the target position, velocities and accelerations. The coefficients are designed user digital and filter design toolbox using Matlab. The following command is used to generate the first order coefficients: [b, a]=butter (n, wn)

Where n is the order of the filter, and wn is the cutoff frequency. For our design, the following are chosen,
n=1, wn=7.5/500 hertz.
   The sample frequency in our design is 1000 hertz, and hence the Nyquist frequency is 500 hertz. The target velocity is generated by using a discrete derivative 306 on the output from the double discrete filters. This design does not offer a proportional rise time for the given delta step size.

A double variable rate discrete first order filter is used for the generation of the target position and velocities. A variable rate filter is used instead of a fixed rate filter to obtain proportional rise times for the given step changes. The following logic is applied where filter time constant (tc) is varied dynamically based on the delta step changes.

Pos_out(i)=Pos_in(i)*(ts/(ts+tc))+Pos_out(i−1)*(tc/(tc+ts) (1)

Pos_in is the delta step change requested. There is a linear gain which modifies the time constant (tc) based on the magnitude of the Pos_in. A discrete derivative is used to obtain the target velocity from the target position.

FIG. 4 illustrates the degree to which target position is brought toward commanded position by substituting variable filters for fixed filters. The plots demonstrate the differences between the fixed and variable filter for the profile generation. The rise time is the same (90% change of the delta step) which is about 100 ms for the delta step 5% and 90% with the fixed filters. The rise time is proportional to a delta step change with the variable discrete filter.

FIG. 5 illustrates a plant model for any of the intake throttle valve 82, the EGR valve 32, or the TM valve 80. The plant model is assumed to be simple mass spring damper system. There is a simple gain to convert the control signal to required torque to drive the valve. Letting x1 be the angular position of the valve in radians and x2 the angular velocity of the valve in radians/sec, the dynamic equation for the valve can be written as,

2=f(x1,x2)+bU (2)

f(x1,x2)=Ks(x1)*x1+Kf(x2)*x2
Ks is the spring constant
Kf is the damping constant
U is the Control signal between −60000, 60000 where 60,000 and −60,000 are the maximum torque outputs in positive and negative directions and “b” is the transfer function from U to Electro-Mechanical Torque.

Referring to FIG. 6, the SMC 604 methodology consists of defining a sliding surface variable S 602 generated by a plant 600, given by

S=e+Kp Kp>0 (3)

e is the tracking error which is the difference between the target position and actual position and is the tracking error, is the difference between the desired velocity and actual velocity.

Assuming a control law such that

S≦−ρ|S| ρ>0 (4)

then the sliding surface (s=0) is reached within a finite time, given by S(t_{—}0)/ρ, where t_{—}0 is the initial time.

The functions f(x) and b are not known exactly but their nominal values are known in terms of the nominal values of plant parameters and current states. Let these be donated by \tilde{ƒ}(x) and \tilde{b}. Assuming that f(x) and b satisfying the below inequalities,

|ƒ−\tilde{ƒ}|≦F (5)

b_min≦b≦b_max (6)

then control law ensures the satisfaction of inequality 3 and helps drive the system to the sliding surface (S=0) within a finite time and

U=Ũ−Ki Sgn(S) (7)

Where Ũ=(1/\tilde{b})(_{2des}−f(x)−Kp·x_{2des})
Sgn is the sign function. It is +1 when S>=0 and −1 when S<0

However, because of Sgn(S), the input U to the plant chatters. This is the major drawback of the classical sliding control design as chatter might trigger unmodeled high frequency dynamics in the system. Also, the high control activity should be avoided which is not practical to implement. The control law should provide durability to the system which might not be possible with high switching frequencies reducing the life of the electronics board, and as well as affecting the mechanical part of the valve with the unwanted vibrations.

One way to smooth the control signal is to replace Sgn(S) with a saturation function sat(S/φ). Here φ is the boundary layer thickness around S=0 where the saturation function is linear in S/φ. For simplicity and practical implementation, the signum component of the control law is replaced as follows,

U_Signum=Kd·S,−Ki≦Kd·S≦+Ki (8)

This assures that when S is large the U component is large enough to drive the surface to zero and when S is small, this component becomes very small and helps minimizes the chattering effect. Ki above is assumed to be largest U possible(ex. 60,000 (maximum effort) in positive direction and −60,000 (maximum effort) in negative direction). The control law (7) can then be modified to

U=Ũ−Kd·S,−Ki≦Kd·S≦+Ki (9)

Though the sliding control design 1 helps to minimize the chattering effect However the design does not guarantee that we would reach sliding surface (S=0) in finite time in all the conditions.

Referring to FIG. 7, a partial solution is to redefine the sliding variable S 704 and 702 as

S= [symbol] +(2·Kp)e+Kp²∫e dt from t0 to t (10)

The integrator term on the tracking error term of position will always ensure that the tracking error on the position will always converge towards 0. Now the control law (9) is modified as

U=Ũ−Kd·S,−Ki≦Kd·S≦+Ki

S is given by equation (8)

Ũ=(1/\tilde{b})(_{2des}−\tilde{f}(x)−2·Kp×e−Kp²e) (11)

Based on experimental evaluation of design 1, it was noted that the nominal values \tilde{f}(x) contributed to a large steady state error for small steady changes. This could be attributed to not a very accurate calibration of the plant model at small step changes. And hence, it seemed reasonable to move ahead with design of putting together an integral control in SMC assuming no nominal spring and damping forces in equation (11).

Ũ=(1/\tilde{b})(_{2des}−2·Kp×e−Kp²e) (12)

Referring to FIG. 8, the fixed filter is changed to the variable filter 802 to have rise times proportional to the delta step changes. This will be helpful during FTP cycles where the variable filter would achieve small step changes in small times whereas the fixed filter would always try to achieve even the small step changes with a higher rise time commanded position profile. Since there is now an integral term on the error term on position in the surface calculation, the control U signal could become noisy if some external disturbance is added to the position feedback. To counter this effect, there is a gain scheduling algorithm added to the control design. The gain schedule has two set of gains. The primary gain set will always act when the position error is above a threshold, and the secondary gains (lower magnitude) kicks in when the position error is below a threshold. The fixed filter is changed to the variable filter to have rise times proportional to the delta step changes. This will be helpful during FTP cycles where the variable filter would achieve small step changes in small times whereas the fixed filter would always try to achieve even the small step changes with a higher rise time commanded position profile.

Refereeing to FIG. 9, in case of an absence of velocity sensor 22 on the shaft, and the challenges of using a differentiator on an angular position signal in real time, a velocity observer 900 is developed for calculating the angular velocity of the shaft. From the structure of the dynamics given by equation 1, the second order velocity observer is designed as follows,

(x2)=y+L*(x1−x1) (13)

Where the auxiliary variable is updated according to the following

=(1/J)*(−f(x1,x2)+b*U) (14)

L is the observer gain which is adapted by performing experiments on the bench top. The function f(x1, x2) is the characterization (spring forces, damping forces), and J is the inertia of the plant model. This is a combination of spring and damping constant lookup tables for the plant model.

Referring to FIG. 10 the noise on U as the integrator terms in the sliding mode controller is reduced by a filter 1000 and the observer contributes to high switching frequencies on the outputs.

Referring to FIG. 11, three gain set comparisons are made to show the impact on controller performance compared to idle controller performance (with gains lambda=80; Gamma=5000; Eta=5000).
Lambda=20; Gamma=5000; Eta=5000
Lambda=40; Gamma=5000; Eta=5000
Lambda=60; Gamma=5000; Eta=5000
   The lambda is a proportional term on the position error in the surface calculation, and evidently from the plots it can be seen that it affects the shape of the position feedback (time between 100 msec and 150 ms). Higher the lambda, higher is the rise time of the position feedback. As seen from FIG. 12, the lambda has an effect on initial acceleration forces which are needed when starting the motor from idle condition. The surface plots show the proportional effect of lambda on S. At 0.1 sec, the magnified error on angular velocity results in a more strong maintained U to reduce the error in S.

Referring to FIG. 13, three gain set comparisons show the differences on the impact of the controller performance compared to the optimal controller performance (with gains Lambda=80; Gamma=5000; Eta=5000)
Lambda=20; Gamma=50000; Eta=100
Lambda=20; Gamma=50000; Eta=1000
Lambda=20; Gamma=50000; Eta=5000
   For the given above gain sets, the control law help drive us to the driving surface. Noticeably, the gain set (20-50000-10) is slower to drive the surface 5 to 0 but the trend shows that it would converge in a finite time. Lowering Eta and control signal is smaller and hence less motor effort to drive the valve to desired position. From the design of the control law, the strength of the control signal to push S towards 0 is directly proportional to this term. Since the acceleration forces (due to motor effort) are too low to counter-act the plant spring and damping forces, the momentum is lost and valve is too low to respond. The Eta effect on U is seen in Control signal plot where when spring and damping forces are dominant over acceleration forces, it pushes the motor effort to maintain the acceleration. This is apparent when Eta is 1000 and 5000.

Referring to FIG. 14, Five gain set comparisons will show the differences on the impact of the controller performance compared to the idle controller performance (with gains Lambda=80; Gamma=5000; Eta=5000)
Lambda=80; Gamma=0; Eta=5000
Lambda=80; Gamma=1000; Eta=5000
Lambda=80; Gamma=5000; Eta=5000
Lambda=80; Gamma=10000; Eta=5000
Lambda=80; Gamma=25000; Eta=5000
   It can be seen that at Gamma=0 (limits on Effective eta term in U) which makes the effective Eta term to be 0; the control law never achieves the sliding surface (S=0). The gamma has a similar effect as Eta on countering the damping and spring forces. Lower the gamma, the control U offers less motor effort to counter the plant forces resulting in a slower response. The control law never achieves the sliding condition with lower Gamma and Eta values because of the absence of additional push needed.

Referring to FIG. 15, on a small step change, from 95% to 85%, the disadvantage of the SMC with no integral control is shown. The steady state error with optimal gains (Lambda=80; Gamma=50000; Eta=5000) and gains with reduced lambda (20) is shown.

Referring to FIG. 16, Three gain set comparisons will show the differences on the impact of the controller performance compared to the optimal controller performance (with gains Lambda=80; Gamma=50000; Eta=5000)
Lambda=20; Gamma=50000; Eta=5000
Lambda=40; Gamma=50000; Eta=5000
Lambda=60; Gamma=50000; Eta=5000
   The proportional effect of Lambda is clearly seen in the plots. For higher lambdas, the higher the rise time of the position feedback. As seen from FIG. 17, lambda has an effect on initial acceleration forces which are needed when starting the motor from idle condition.

Referring to FIG. 18, two gain set comparisons will show the differences on the impact of the controller performance compared to the optimal controller performance (with gains Lambda=80; Gamma=50000; Eta=5000)
Lambda=80; Gamma=50000; Eta=100
Lambda=80; Gamma=50000; Eta=5000
   The higher value of eta helps to push S towards the sliding surface (S=0) as seen the above plot. When S is large (8800 @ 65th sec), the larger value of Eta pushes U to make S converge towards sliding surface (S=0) faster than when Eta is small (Eta=100). With Eta=5000, the S reaches close to the sliding condition (S=0) @ 130th sec, and the braking action in U could be seen (drop in U) to reach the sliding condition.

Referring to FIG. 19, two gain set comparisons will show the differences on the impact of the controller performance compared to the optimal controller performance (with gains Lambda=80; Gamma=50000; Eta=5000)
Lambda=80; Gamma=10000; Eta=5000
Lambda=80; Gamma=25000; Eta=5000
   Gamma offers the same advantage as the Eta term. The higher the value for Gamma faster is the time to reach the sliding surface.

Referring to FIG. 20, the advantages of the second controller arrangement over the first control arrangement. The U provides 100% motor effort for first 80 ms as against 100% motor effort for the first 50 m sec. This results in quicker rise times. The second control arrangement gets the valve to 80% in 100 m sec whereas the first arrangement gets the valve position to 65%. The slowing action with S approaching sliding condition could be seen in the control signal.

Referring to FIG. 21 The second controller design (with help of integral control) helps the surface (S) to converge towards 0. The first controller design 1 shows a slow convergence of S and eventually there always exists a steady state error in the position. The control design 2 does not show any steady state error.

Referring to FIG. 22 sliding mode control could produce noise on U because of the integral term on error on position in the surface calculation. The integral term on error is the surface calculation is squared which could cause U to oscillate in case there are any external disturbance to the system. For example, the EGR valve was showing chattering (as circled) at end stops because the position calculation algorithm for the Hall effect sensor was not accurate at the boundary conditions (5 and 95) causing the chattering effect. To reduce the chattering phenomena, gain scheduling was added reduce any external disturbance. The logic uses a comparator to schedule gains depending on the magnitude of the error. If the error is greater than 2 degrees, the stronger gains (Lambda1, Gamma1 and Eta1) are used, and when the error is less than 2 degrees, the secondary sets of gains are used.

The results of FIG. 23 were achieved using no gain schedule. Gains were chosen after experimenting the valve on the bench with repeated experiments.

Primary gains (when error on position is greater than 2 degrees)
Lambda1=75
Gamma1=4000
Eta1=4000

Secondary gains (when error on position is less than 2 degrees)
Lambda2=65
Gamma2=3000
Gamma2=3000

Referring to FIG. 24 a step change of 5-95% is illustrated while FIG. 25 is for a step change of 5 to 10%. The noise on U and chattering effect is reduced at the end stops with the gain scheduling algorithm of FIG. 24. The plot shows a smooth position feedback at 95% (boundary condition). For FIG. 25 a variable filter shows a 60 ms rise time.

The controllers developed (SMC Fixed rate, SMC Fixed rate with integral control, and SMC variable rate with integral control) for the given hardware helps to achieve faster valve performance, remove steady state errors and remove erratic behavior. The controller law whether linear or non-linear should take account of the hardware variability's, instabilities and external noise factors to produce required performance attributes. SMC defines a sliding surface (S) which is first order function of error on displacement and velocity. The controller law guarantees reaching the sliding surface (s=0) notwithstanding external disturbances such as flow forces, or hardware uncertainties. The control law has a profile generator, surface calculation, velocity observer, and a first order filter on the controller output. The fixed rate filter is used to provide same position and velocity profiles irrespective of the step changes. Whereas variable rate filter provides proportional position and velocity profiles depending on delta step changes.

The system provides valve step response (5-95) below 125 ms, starts valve movement below 10 ms when commanded, provides stable valve control, provides faster response valves means faster reaction to requested egr flows for lower NOx, reduces chattering which is common to classic SMC, provides for stable valve positioning for onboard diagnostic development, the controller could be quickly adapted to different valves like EGR, TM, intake throttle etc., and finally the controller could be quickly adapted per requirements like rise time etc.

1. A sliding mode controller for one or more valves in an engine induction or exhaust system comprising:
filter means for generating position and velocity profiles for the valve or valves; and
means for controlling valve chattering including one or more of means for generating a boundary layer and a low pass filter for processing a control output to be applied to a valve actuator.

2. The sliding mode controller as set forth in claim 1, further comprising:
means for changing the gains on the filters for generating position and velocity profiles.

3. The sliding mode controller as set forth in claim 2, further comprising:
the means for changing gains providing a means for achieving variable rise times.

4. The sliding mode controller of claim 1, the filter means further comprising:
double discrete fixed rate filters to generate position and velocity profiles.

5. The sliding mode controller as set forth in claim 2, wherein an error greater than a threshold results in a set of gains with a higher magnitude being implemented and wherein an error less than a threshold results in use of lower magnitude gains.

6. A method of valve control in a fluid control system comprising the steps of:
generating position and velocity profiles for a valve or valves; and
controlling valve chattering by generating a boundary layer or by applying a valve positioning signal to a low pass filter.

7. The method of claim 6, comprising the further step of:
changing the gains used to generate position and velocity profiles.

8. A control apparatus for an exhaust system for a motor vehicle engine and an induction system for the motor vehicle engine, the control apparatus comprising:
a thermal management valve in the exhaust system;
an exhaust gas recirculation control valve for coupling exhaust gas from the exhaust system to the induction system;
a controller;
a profile generator executed on the controller for generating target position control inputs for the thermal management valve and the exhaust gas recirculation valve and for generating target velocity control inputs for the valves during movement between target positions;
means for calculating a sliding mode control surface combining an error on valve positions and velocity;
means for calculating a control law to drive the sliding mode control surface toward zero to minimize the error on valve position and valve velocity between position; and
position feedback signals for the exhaust gas recirculation control valve and the thermal management valve.

9. The control apparatus of claim 8, further comprising:
a first order velocity observer function implemented on the controller responsive to input and position feedback for estimating valve velocity between positions.

10. The control apparatus of claim 9, further comprising:
a low pass filter on the output of the means for calculating.

11. The control apparatus of claim 10, further comprising:
means for limiting valve chattering including a boundary layer implementation.

12. The control apparatus of claim 10, further comprising:
means responsive to position feedback for scheduling gain on the target position input and target velocity input to limit chattering.

13. A method for controlling motor vehicle engine exhaust and induction system valves including a thermal management valve, an exhaust gas recirculation control valve for coupling exhaust gas from the exhaust system to the induction system and an induction throttle, the method including the steps of:
responsive to a valve position setpoint generating target position control inputs for the thermal management valve and the exhaust gas recirculation valve and for generating target velocity control inputs for the valves during movement between target positions;
calculating a sliding mode control surface combining an error on valve positions and velocity;
calculating a control law to drive the sliding mode control surface toward zero to minimize the error on valve position and valve velocity between position; and
generating position feedback signals for the exhaust gas recirculation control valve and the thermal management valve.

14. The method claim 13, further comprising:
generating a first order velocity estimation responsive to the inputs and to position feedback signals.

15. The method of claim 14, further comprising:
low pass filtering an output from the control law calculating step.

16. The method of claim 15, further comprising;
limiting valve chattering by including a boundary layer implementation.

17. The method of claim 15, further comprising:
responsive to position feedback scheduling gain on the target position input and target velocity input to limit chattering.
